(19) United States
(12) Patent Application Publication
(10) Pub. No.: US 2023/0088092 A1
(43) Pub. Date: Mar. 23, 2023

(54) PHOTOACTIVE PIGMENT CLUSTERS FOR DURABLE COATING APPLICATIONS

(71) Applicant: SWIMC LLC, CLEVELAND, OH (US)

(72) Inventors: Robert A. MARTUCH, Parma, OH (US); Stephanie L. CASTRO, Westlake, OH (US); Joseph K. WALKER, Jr., Mentor, OH (US)

(21) Appl. No.: 17/905,361

(22) PCT Filed: Mar. 5, 2021
(86) PCT No.: PCT/US2021/021048

§ 371 Date: Aug. 31, 2022

Related U.S. Application Data
(60) Provisional application No. 62/986,256, filed on Mar. 6, 2020.

(51) Int. Cl. C08K 9/06; C09D 5/02; C09D 7/61; C09D 7/65; C08K 9/08; C09D 7/63

(52) U.S. Cl. CPC C08K 9/06; C09D 5/028; C09D 7/61; C09D 7/65; C08K 9/08; C09D 7/63; C08K 2201/005

(57) ABSTRACT

A photoactive cluster particle for durable latex paint compositions and said durable paint compositions, the photoactive cluster particle including a binder that coalesces cluster components into a cluster particle. The cluster components of the cluster particle include a photoactive component, one or more silicon-containing particles (may act as the binder), optional discrete polymeric particles each defining a closed void volume therein, optional non-photocatalytic inorganic pigment particles, optional organic latex polymer, and optional extender pigment particles. The photoactive cluster particle further includes an interstitial void network of the cluster particle forming a porosity thereof.

### FIELD

This disclosure relates generally to photoactive pigment clusters and, more particularly, photoactive pigment clusters that provide a durable and photoactive system for use in coating applications.

### BACKGROUND

Professional and residential consumers of surface coatings, such as architectural paints, prefer products that maintain a fresh, clean, and maintenance-free surface. With exterior coatings, the sun and weather tend to degrade the coatings and fade colors over time. Moreover, dirt and grime can build up on the surface of the coating, such as in the form of streaking around windows, under eaves, and the like, which tends to be unsightly and difficult to clean or repair. Power washing of the coated surfaces tends to be messy and labor intensive and may not completely rejuvenate the coating's appearance. Frequent repainting is also labor intensive and costly to the consumer.

Previous attempts have been made to fabricate active coating systems that attempt to maintain a clean surface of the coating. These active systems commonly included some type of a photocatalytic pigment that oxidizes organic compounds in the presence of oxygen, moisture, and/or UV radiation. However, prior systems using such active technology have the shortcoming that the photocatalytic pigments not only oxidize organic grime and other impurities on the surface of the coating, but the photocatalytic pigments also actively oxidize organic polymers and other organic components of the coating at the same time. Thus, prior active coating systems slowly disintegrated the coating itself.

Chalking is an undesired process whereby a coating decomposes due to its organic components degrading or breaking down over time. This decomposition leads to exposed pigment particles in the coating. In extreme circumstances, the pigment particles become loose or lose adhesion within the coating. Often, chalking is due to weathering or other environmental exposure degrading the organic compounds in the coating. Prior photocatalytic systems tend to accelerate chalking because of the enhanced degradation of the organic component. As a result, prior attempts at active coating systems are undesirable because they do not form a durable coating or paint system.

### SUMMARY

According to one aspect, a photoactive cluster particle for durable latex paint compositions is disclosed, the photoactive cluster particle comprising a binder that coalesces cluster components into a cluster particle, the binder comprising one or more silicon-containing particles; the cluster components of the cluster particle including a photoactive component, which is preferably a photoactive pigment particle (in some embodiments anatase titanium dioxide in a photocatalytic form), optional discrete polymeric particles each defining a closed void volume therein, optional non-photocatalytic inorganic pigment particles, optional organic latex polymer, which may or may not also form a portion or all of the binder, and optional extender pigment particles; and an interstitial void network of the cluster particle forming a porosity thereof.

In certain embodiments, the photoactive cluster particle for durable latex paint compositions comprises about 1 percent to about 30 percent by volume of the binder (as a percentage of the dry, solid cluster volume; not including void volume), wherein the binder comprises the one or more silicon-containing particles, about 1 percent to about 90 percent by volume of the photoactive component, about 0 to about 85 percent by volume of the non-photocatalytic inorganic pigment particles, about 0 to about 80 percent by volume of the discrete polymeric particles each defining a closed void volume therein, about 0 to about 25 percent by volume of the organic latex polymer, and about 0 to about 90 percent by volume of the extender pigment particles.

According to another aspect of the invention, a durable and photoactive latex paint composition with both photoactive and non-photoactive pigments is disclosed, the latex paint composition comprising: solvent, a polymeric paint formulation binder, non-photocatalytic pigment particles, and photoactive cluster particles; the photoactive cluster particles including a cluster binder comprising one or more silicon-containing particles and the same or a different organic latex polymer as the polymeric paint formulation binder or no organic latex polymer, the cluster binder coalescing cluster components into a discrete cluster particle, wherein the cluster components of the discrete cluster particle include a photoactive component (preferably titanium dioxide in a photocatalytic form), optional discrete polymeric particles each defining a closed void volume therein, optional non-photocatalytic inorganic pigment particles, and optional extender pigment particles, and wherein the discrete cluster particle has an interstitial void network forming a porosity thereof.

### BRIEF DESCRIPTION OF THE DRAWINGS

FIG. 1 shows a schematic view of an exemplary photoactive pigment cluster;

FIG. 2 shows a schematic view of another exemplary photoactive pigment cluster;

FIG. 3 shows a schematic view of an exemplary spray drying apparatus that is useful for forming photoactive pigment clusters herein;

FIG. 4A shows a scanning electron microscopic image of an exemplary photoactive pigment cluster;

FIG. 4B shows a scanning electron microscopic image of a non-photoactive cluster;

FIG. 5A shows a schematic, cross-sectional view over time of a paint film including photoactive titanium dioxide, but no photoactive clusters and FIG. 5B shows a schematic, cross-sectional view over time of a paint film including photoactive titanium dioxide contained in exemplary photoactive clusters;

The drawings herein are not necessarily drawn to scale, and schematic views do not necessarily represent the actual product or components thereof, but they are intended to generally represent various components thereof.

### DETAILED DESCRIPTION

Described herein are photoactive cluster particles suitable for coatings, such as latex paint compositions. The photoactive cluster particles when incorporated into a coating form an active coating system that tends to oxidize dirt and grime on the coating surface but minimizes and/or controls the degradation of the organic componentry in the coating formulation at the same time. In this regard, the photoactive clusters are unique because they segregate in distinct domains the photoactive components separate from and/or spaced from the conventional coating componentry in a paint composition. Thus, these unique clusters minimize and/or control the degradation of the organic coating components due to the photoactive components.

In one aspect, a photoactive cluster particle is described herein that includes a binder that coalesces cluster components into a discrete cluster particle, wherein the binder comprises one or more silicon-containing particles. The cluster components of the discrete cluster particle typically include photoactive components (in one approach, titanium dioxide in a photocatalytic form), optional discrete polymeric particles each defining a closed void volume therein, optional non-photocatalytic inorganic pigment particles, an optional, additional binder component that is an organic binder, and optional extender pigment particles. These photoactive cluster particles tend to further include an interstitial void network within the cluster particle forming a porosity thereof. This interstitial network includes pores, voids, channels, or other network spaces of a size such that paint formulation binders, other organic coating componentry, and other larger components of a coating or paint that the clusters are blended in do not enter the voids or pores of the cluster particle.

The photoactive cluster particles herein are suited for coatings, such as latex paints and provide a durable and active coating system. When the photoactive cluster particles are blended into a coating or other paint composition, the organic components of the coating or paint formulation generally do not enter or flow into the void space or network of the cluster particle. The photoactive cluster particle, thus, tends to remain a discrete or separate domain within the coating which tends to aid in minimizing contact between the photoactive components and organic coating components.

Certain terminology is used herein for convenience only and is not to be taken as a limitation on the present disclosure. Relative language used herein is best understood with reference to the drawings, in which like numerals are used to identify like or similar items. Further, in the drawings, certain features may be shown in somewhat schematic form.

“Opacity” as used herein generally refers to the ability of a film to scatter light based on the thickness of the film. The opacity is often expressed as S/mil and may be in the form of Kubelka-Munk scattering coefficients as determined using a modification of ASTM D2805-70 as described by J. E. McNult and H. L. Ramsey in American Paint and Coatings Journal, April 1988 p. 46 by the weight drawdown method, which is incorporated herein by reference.

“Opaque polymer” as used herein generally refers to a polymer or polymeric particle/network that encloses or substantially encloses a defined volume or space. Opaque polymers are often considered in certain regards as pigment in a coating formulation. An opaque polymer may be a discrete polymeric particle where each polymer particle defines a closed void volume or cavity therein. In some embodiments, an opaque polymer comprises polystyrene. Opaque polymers are commercially available from commercial vendors. Exemplary commercially available opaque polymers are Ropaque Ultra EF and/or Ropaque OP-96 EF (both available from the Dow Chemical Company, Midland, Mich.). In certain embodiments, the defined volume of an opaque polymer comprises air forming a void that scatters light. In certain other embodiments, the defined volume of an opaque polymer comprises a liquid such as water. For embodiments including a liquid within the defined volume, the liquid is eventually replaced with air, creating a void that scatters light. Opaque polymers may be used as a partial replacement for non-photoactive TiO₂ in paints or other coatings to enhance hiding and whiteness in paints and coatings.

“Binder void volume” or “interstitial void network volume” as used herein refer to the volume percentage of a coalesced structure of a photoactive cluster (such as a coalesced binder) that comprises air pockets when applied as a part of a coating to a surface and dried.

“Opaque polymer void volume” or “discrete polymeric particle closed void volume” as used herein refer to the volume of the void that is enclosed by, or substantially enclosed by, an opaque polymer or discrete polymeric particle.

“Void volume” as used herein refers to the volume percentage of a material that comprises air when applied as part of a coating to a surface and dried. “Total void volume” is generally the sum of opaque polymer void volume and binder void volume.

“Photoactive clusters” or photoactive pigment clusters as generally used herein refers to different cluster components, such as binder, pigments (photoactive and optional non-photoactive pigments), silicon-containing particles or additives (which may operate as all or a potion of the binder), optional opaque polymers, optional extenders, polymer latex particles (which may operate as all or a portion of the binder), and/or other optional materials which may be used to enhance, or otherwise change the properties of, a paint composition wherein these cluster components are coalesced together into discrete or engineered particles including nano-sized and/or micron-sized components as described further herein. In some embodiments, the photoactive clusters are discrete particles not held together with chemical bonding or covalent bonding. In other embodiments, components of the photoactive clusters are not held to other components with hydrogen bonding or other types of chemical bonding. Rather, the cluster components are coalesced and bound together, in one approach, via spray drying to coalesce the components into a particle.

“Pigment volume concentration” or “PVC” as used herein refers to a number that represents the volume of pigment compared to the volume of all solids. In the field of paints and coatings, PVC is a useful measure because the paint formulation binder (non-pigment) acts as the material to unite all the pigment and other raw materials into the paint and the PVC value can be used to ensure there is enough paint formulation binder to enable the paint to adhere properly to whatever it has been applied over in addition to containing all of the other components of the paint. If a paint has no pigment at all it will usually be very glossy and have a PVC of zero. An example is clear gloss paints. Flat paints have a very high pigment loading and have high PVCs (usually in the range from about 55% up to about 80%). Another non-limiting exemplary range of PVC in which pigment can be loaded is from about 60% to about 75%. Primers and undercoats vary from 30% to about 50% PVC, as do semi-gloss, satin and low sheen paints. Gloss, colored paints can vary from 3% to about 20% PVC depending on the color of the paint. Generally the darker the color of the gloss paint, the lower the PVC. Additionally, it is thought that the lower the PVC of a paint, the better its mechanical properties (such as tensile strength, and consequently, exterior durability) will be. PVC may be expressed as a percentage. For example, if a coating has a PVC of 30, then 30% of the total paint formulation binder/pigment blend may be pigment, and 70% may be paint formulation binder solids on a volume basis. In the present specification, volume of cluster is treated as part of the pigment volume of a paint for purposes of determining PVC.

“Critical pigment volume concentration” or “CPVC” as used herein is the point at which there is just enough paint formulation binder to wet (entirely surround) the pigment particles in a paint. As PVC reaches and then increases above CPVC, mechanical properties of the paint deteriorate. Above CPVC, with insufficient paint formulation binder to satisfy pigment surface and fill interstitial spaces, air is introduced into the film resulting in a decrease in film integrity. However, above CPVC, increased air and pigment interface results in a substantial boost in pigment light scattering efficiency. A film below the CPVC has excess resin and may exhibit a smooth surface that reflects light or appears to be glossy. As the PVC of a film approaches CPVC from below, the film will appear to be flatter, although the aforementioned loss of mechanical properties may become a limiting factor in how close to CPVC a paint producer wishes to provide a paint.

“Y_{black}” as used herein represents the reflectance value of a coating and measures the ability of a coating to cover against a black background. Measurement of Y_{black} may be done as part of measurement of contrast ratio.

“Y_{white}” as used herein represents the reflectance value of a coating and measures the ability of a coating to reflect light against a white background. Measurement of Y_{white} may be done as part of measurement of contrast ratio.

“Contrast Ratio” as used herein is calculated as Y_{black}/Y_{white} and is the ratio of the reflectance of a film on a black substrate to that of an identical film on a white substrate. ASTM D2805-11 provides for the measurement of contrast ratio.

“Y-reflectance” as used herein refers to the ratio (typically expressed as a percentage of perfect reflectance) of the flux reflected from a specimen relative to the flux reflected from the perfect reflecting diffuser under the same geometric and spectral conditions of measurement. The CIE Y metric, used to measure Y-reflectance herein, is scaled between 0 (representing a Perfect Black of 0% reflectance across the visible spectrum) and 100 (representing a Perfect White of 100% reflectance across the visible spectrum). Y-reflectance may also be referred to as the “reflectance factor” as described in ASTM E284 (Standard Terminology of Appearance).

“Delta L” refers to a measure of difference in lightness for a paint/coating film, and as discussed in the present specification, it is expressed as described in the FMC-II (“Friele MacAdam Chickering”) color difference scheme. Delta L is assessed using a spectrophotometer and calculations according to FMC-II.

“Binder” as used herein and with reference to the inventive photoactive clusters is a material that may be used to form a cluster from different components (e.g., pigments, silicon-containing particles, latexes, extenders, and/or opaque polymers) by coalescing and mechanically connecting the components. Binder, with reference to the inventive photoactive clusters may refer to an inorganic binder, an organic binder, or a combination of the two. Silicon-containing particles may act as an inorganic binder and are the preferred binder herein. Latex polymers are a non-limiting example of an organic binder that may be dispersed in water using a dispersant. Film formation (or other network formation) occurs by joining (or coalescence) of solid binder particles as water or other solvent evaporates or is otherwise driven off. Latex polymers may be present in combination with silicon-containing particles to form an additional binder in a cluster. Exemplary silicon-containing particle binders include silica and silicates. Exemplary latex binders that may be used in the present disclosure include, but are not limited to, polyvinyl acetates, vinyl acrylics, styrene butadiene, styrene acrylics, and ethylene vinyl acrylics. Other exemplary binders include, but are not limited to, solvent-borne binders and water reducible binders. Exemplary binders may also be selected to minimize or reduce photoactive degradation of the photoactive cluster particles by a photoactive component.

“Paint formulation binder” as used herein is a material that may be used to coalesce and participate in film formation of a bulk paint film, including components of a paint as defined herein by coalescing and mechanically connecting the components. Latex polymers are a non-limiting example of a paint formulation binder that may be dispersed in water using a dispersant. Film formation (or other network formation) occurs by joining (or coalescence) of solid paint formulation binder particles as water evaporates or is otherwise driven off. Exemplary paint formulation binders which may be used in the present disclosure include, but are not limited to, polyvinyl acetates, vinyl acrylics, styrene butadiene, styrene acrylics, and ethylene vinyl acrylics. Other exemplary paint formulation binders include, but are not limited to, solvent-borne binders and water reducible binders. Exemplary paint formulation binders may also be selected to minimize or reduce photoactive degradation of the paint by a photoactive component in the clusters, or to balance photoactive cleaning with degradation/chalking of the paint.

“Small size extender” as used herein refers to extender pigment particles of small particles of minerals, clay, ground and precipitated silica, or other fillers which may be used to reduce the quantity of the pigment required to achieve a desired hiding ability, sheen, etc., without significantly affecting the color of the paint established by the pigment. In some approaches, small size extenders generally have a particle size of less than 1 micron, and in some other approaches, about 0.1 micron to about 1 micron. Small size extenders that may be purchased commercially include but are not limited to Omyacarb UF (Omya North America). In some approaches, the small size extender pigment particles are used within the photoactive cluster particles, but these smaller extenders may also be used in the paint formulation as well. Any suitable small size extender that one of skill in the art would use in a coatings application may be used in the paint and coatings products of the present disclosure without departing from the scope of the present disclosure.

“Large size extender” as used herein refers to extender pigment particles of larger particles of minerals, clay, or other fillers which may be used to reduce the quantity of the pigment required to achieve a desired hiding ability, sheen, etc., without significantly affecting the color of the paint established by the pigment. Large size extenders typically have a particle size of greater than about 5 microns. In some embodiments, a large size extender has a particle size of about 5 microns to about 50 microns. In other embodiments, a large size extender is from about 10 microns to about 15 microns in size. Typically, the large size extender pigment particles are not used or coalesced within a photoactive cluster, but otherwise added to a latex paint composition in addition to the clusters. However, large size extenders may also be used within a cluster particle as needed for a particular application.

“Pore” as used herein refers to an opening at the surface of a structure such as a polymer, cluster, or photoactive cluster that may lead to an internal interstitial network. In one embodiment, a pore may form at the outer surface of a photoactive cluster between the components of the outer surface of a photoactive cluster, which in exemplary embodiments may comprise components selected from the group consisting of: binders (inorganic or organic binders), opaque polymers, small-size extenders, pigments (photoactive and/or non-photoactive), and combinations thereof.

“Interstitial network” as used herein generally refers to a plurality of pores and/or internal openings, voids, and/or channels extending within and/or through a cluster particle. An interstitial network may have a tortious pathway through the particle, and may include more than one such opening, void, channel, and the like that are interconnected and/or may form discrete pathways through the particle.

“Sheen” as used herein may also sometimes be referred to as “gloss”. It is thought that because most extenders have a refractive index of light that is close to the refractive index of the paint formulation binders of most coatings, below CPVC an extender/latex film will be largely transparent to visible light. In a coating, a gloss finish indicates that the surface which has a coating applied to it (i.e., is “finished”) is shiny or glass-like. The gloss of a coated surface is described as the reflection of light from the surface that is independent of color. ASTM D523 or D532-14 may be used to measure sheen. The prescribed angle at which light is reflected off the surface may vary, but for the purposes of this disclosure, 85 Sheen, is measured at 85° relative to the surface reflecting the light. ASTM D523 or D532-14 may also be used to describe 60 Gloss, which is measured at 60° relative to the surface reflecting the light. One of skill in the art is able to determine relative levels of gloss (low versus high) in the context of each coating.

“Paint” as used herein refers to any mixture comprising different types of raw materials, each with its own function, which must be balanced to achieve the desired properties in the final product or film coating. The two primary functions of paint are decoration and protection. A paint may contain a solvent (which can include a volatile component derived from a petroleum distillate for a solvent-based paint, or a low VOC, or no-VOC, or water for a water-based paint), a paint formulation binder, a pigment, fillers (such as an extender or a plurality of extenders of different sizes) and additives, which may impart different functionality to the paint or final coating. Embodiments may include a photoactive cluster as a component thereof, optionally in combination with at least one of the solvent, paint formulation binder, pigment, filler and additive.

“Burnish resistance” as used herein refers to the ability of a coating to retain its gloss value after being subjected to mechanical forces, such as abrasion. Burnish resistance may be measured through ASTM D6736-08.

“Refractive Index” as used herein refers to a measurement that describes how light propagates through a material or medium. If needed, refractive index may be measured through one or more of ASTM D1218, D1747, or D542.

“Chalking” as used herein generally refers to a process whereby organic components of a coating are degraded to expose pigments. Degree of chalking may be determined or assessed by referring to ASTM 4214-07 (2015).

“Photoactive” or “photoactivity” as used herein generally refers to the ability of a pigment particle to react with UV light to generate OH or peroxy radicals in the presence of moisture and oxygen.

“Durability” as used herein generally refers to the ability of a coating including the photoactive clusters to minimize degradation and/or chalking while still maintaining photoactive properties.

Turning to more of the specifics, the present disclosure is directed to compositions of, methods for using, and methods for making photoactive cluster particles that are suited to form a component of durable photoactive surface coatings, such as photoactive latex paints, which provide, among other features, a durable surface film or coating having photoactive features. The unique photoactive clusters of the present disclosure may also provide increasing opacity with increasing PVC similar to the commonly used prior opaque polymers and other pigments, but contrary to the prior opaque polymers, the clusters herein can also be used to reduce gloss and sheen (similar to large size extender particles) to achieve a matte or egg-shell finish. Thus, the clusters herein may be used not only to provide photoactive systems in durable paints and coatings, but also to do so over a wide range of gloss and sheen values without compromising on film opacity.

In one approach or embodiment, the photoactive clusters herein are discrete particles of coalesced components providing, when used in a coating, a distinct domain separate from the traditional paint components in a paint formulation. The photoactive clusters are discrete particles of coalesced components including at least one photoactive component, one or more silicon-containing particles that may act as a binder, optional discrete polymeric particles each defining a closed void volume, optional polymeric latex particles that may act as a binder, optional non-photocatalytic inorganic pigment particles, and optional extender pigment particles. In one approach, a photoactive cluster may include about 0 percent to about 30 percent by volume of the polymeric latex binder, about 1 percent to about 90 percent by volume of the photocatalytic component, about 2 percent to about 25 percent by volume of the one or more silicon-containing particles, about 0 to about 89 percent by volume of non-photocatalytic inorganic pigment particles, about 0 to about 50 percent by volume of the discrete polymeric particles each defining a closed void volume therein, and about 0 to about 20 percent by volume of the extender pigment particles. As described in additional detail herein, the amount of cluster components may vary from photoactive cluster to photoactive cluster and depends on the input feeds during the manufacture of the clusters.

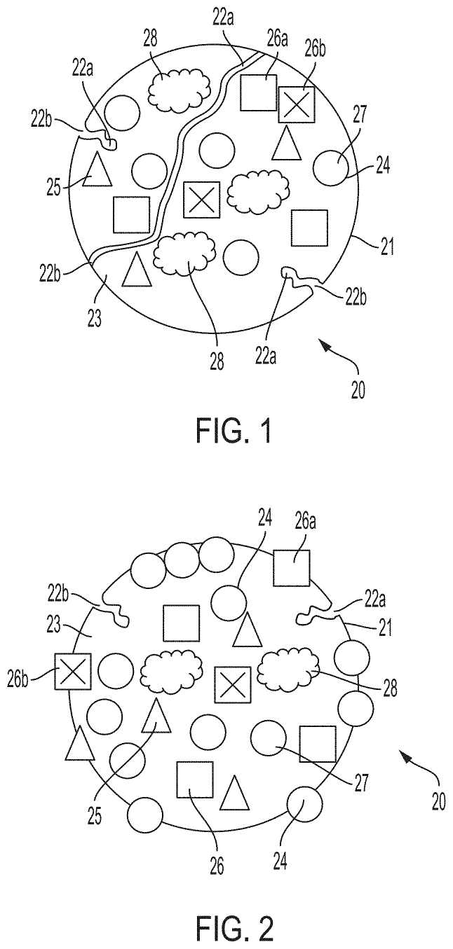

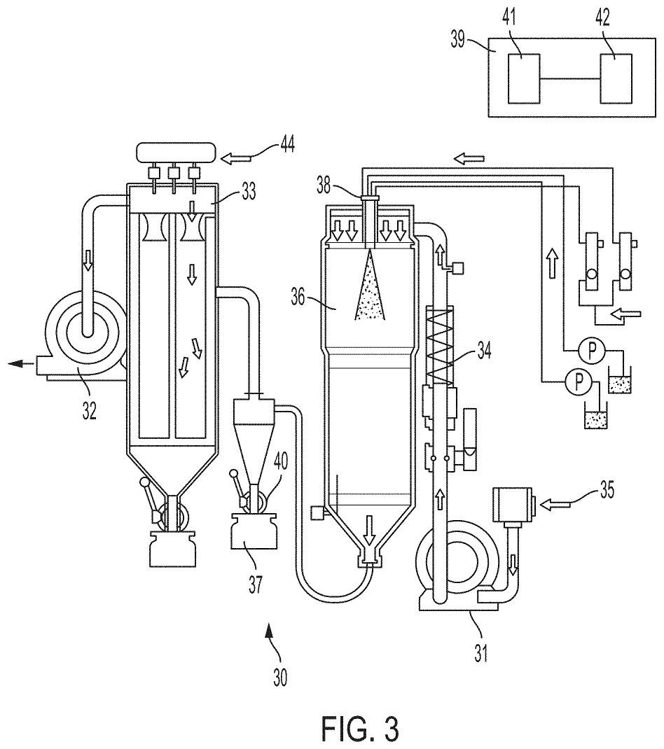

FIGS. 1 and 2 schematically show cross-sectional views of an exemplary photoactive cluster 20. For example, the cluster 20 may include a volume of binder material 23 having an outer cluster surface 21 wherein the outer surface further includes a plurality of interstices 22a (or portions of an interstitial network) and/or pores 22b extending on, in, or throughout the cluster particle (only a couple are shown, but the cluster may include others that extend through a tortuous path throughout the cluster particle) forming an interstitial network of the particle 20. The plurality of pores/interstices 22 may collectively establish or form part of the interstitial network and/or porosity of the photoactive cluster 20. In some cases, a discrete cluster particle may also include larger, internal voids or spaces 28 defining a pocket or other void volume within binder and/or between other cluster components and/or between binder and other cluster components.

In some approaches, the cluster components that the binder 23 coalesces into a discrete particle may include opaque polymer particles 24 (or discrete polymeric particles each defining a closed void volume therein), silicon-containing particles 25, photoactive pigment particles 26a, non-photoactive pigment particles 26b, and various combinations thereof. It is noted that the silicon-containing particles 25 as represented in FIGS. 1 and 2 are shown as being separate from and coalesced by the binder 23, but in other instances in embodiments herein, the silicon-containing particles act as the binder material.

In some approaches, the outer cluster surface 21 includes the binder material 23 or polymeric latex binder as generally shown in FIG. 1. In another approach, the outer surface may also include any number of other cluster components which may be the binder 23, opaque polymers 24, pigments 26a or 26b (photoactive and/or non-photoactive), silicon-containing particles 25 or various combinations thereof as generally shown in FIG. 2.

In some embodiments, the interstices or pores 22 and, in some instances, the channels or voids forming the interstitial network have a diameter or cross-sectional size ranging from about 0.050 microns to about 0.150 microns. In other embodiments, the space forming the pores or other interstitial network have a diameter or size of about 0.08 to about 0.1 microns. Without wishing to be limited by theory, it is believed that because of the relatively small size and the relative tortuosity of the pores, interstices, or interstitial network structure of a photoactive cluster 20, latex from a paint composition in which the photoactive cluster is included does not enter into the voids or interstitial network. The latex material from a paint composition, therefore, does not displace air inside the voids, pores, or interstitial network inside the photoactive cluster 20. Thus, not only do the clusters herein provide photoactive characteristics as discussed more below, the clusters also provide improved optical qualities and a light scattering ability rendering the photoactive cluster 20 as an effective alternative to large-size extenders, opaque polymers, pigments, and other such additives commonly used in coatings to improve hide and coverage at the same time.

The clusters include a photoactive component, which is preferably a photoactive pigment particle. In one approach, the photoactive component is anatase titanium dioxide in a photocatalytic form. The titanium dioxide is photo-chemically active and in the presence of moisture and oxygen generates OH- and/or peroxy-radicals that oxidize organic material when the cluster and the titanium dioxide therein are exposed to UV radiation. To this end, the anatase titanium dioxide particles are free of or devoid of any treatments, surface coatings, or encapsulations that are universally applied to pigments used in the paint and coatings industry. For instance, the photoactive anatase titanium dioxide of the present disclosure is free of oxide surface coatings, such as silicon dioxide, alumina oxide, and the like surface coatings or encapsulation. Suitable anatase photoactive titanium dioxide may be Kronos® 1000 obtained from Kronos, Inc. (Clarksville, Tenn.).

In other approaches, the photoactive component may include rutile titanium dioxide in a photocatalytic form. To this end, the photoactive rutile titanium dioxide particles, if included in the clusters, are also free of or devoid of any treatments, surface coatings, or encapsulations that are universally applied to pigments used in the paint and coatings industry. For instance, the photoactive rutile titanium dioxide of the present disclosure is free of inorganic oxide surface coatings, such as silicon dioxide, alumina oxide, and the like surface coatings or encapsulations.

In yet other approaches, the cluster particles herein may include blends of both rutile and anatase titanium dioxide where both are in a photocatalytic form. If blends of both photoactive anatase and photoactive rutile titanium dioxide are included in the cluster, a cluster may include about 0.1 to about 89.9 percent by volume of photoactive anatase titanium dioxide and about 0.1 to about 89.9 percent by volume of photoactive rutile titanium dioxide. In other approaches, if a blend of photoactive titanium dioxide is included in a cluster, the cluster may include about 2 to about 899 times more by volume of the photoactive anatase titanium dioxide than the photoactive rutile titanium dioxide.

Another component of the cluster is one or more inorganic binders. The inorganic binder serves to provide a structure to limit the photoactive component of the inventive clusters from reactively interacting with organic components of either the inventive clusters or a bulk paint or coating in which the clusters are included. Inorganic binders as used herein are selected from inorganic materials to provide coalescence of cluster components. In certain embodiments, preferred inorganic binders are silicon-containing particles, and in some approaches, a blend of silicon-containing particles. The one or more silicon-containing particles may include silicon dioxide (silica) particles, silicate particles, feldspar, nepheline syenite (e.g., Minex® 10, available from Sibelco), or mixtures thereof. In one preferred approach, the one or more silicon-containing particles include or are derived from LUDOX® HS-30 (colloidal silica, available from W. R. Grace & Co., Columbia, Md.). In another preferred approach, the one or more silicon-containing particles include or are derived from LUDOX® AS-40 (colloidal silica, available from W. R. Grace & Co., Columbia, Md.). In one further approach, the photoactive clusters include a blend of both silicon dioxide particles and silicate particles.

In some approaches, the silicate particles are alumina silicate particles. In yet other approaches, the alumina silicate particles are a sodium-potassium alumina silicate produced from nepheline syenite. In some approaches, the alumina silicate is silica deficient and, in other approaches, contains less than about 1 percent silica by weight, in other approaches, less than about 0.5 percent silica by weight, and in yet other approaches, less than about 0.1 percent silica by weight. The silicate particles are relatively large and have an average particle size of about 1 to 4 microns. Typically, the silicate particles are anhydrous minerals having a moisture content of about 0.2% or less and are photo-chemically stable.

In certain embodiments, silica or silicon dioxide particles used in the cluster are relatively small and typically are nano-sized with a sub-micron average particle size of about 5 nm to about 200 nm.

The photoactive cluster may also include an organic binder or organic binder material such as a polymeric latex binder, to mechanically coalesce or bind the various components of the photoactive cluster into a discrete cluster particle. Such organic binder may provide additional coalescence in addition to that provided by an inorganic binder. In certain embodiments, the cluster may include only organic binder and not inorganic binder, though it is preferred that at least some inorganic binder be present in the clusters. Preferred binders include silicon-containing particle binders. Such silicon-containing particle binders may operate as the sole binder (i.e. in the absence of a polymeric latex co-binder). The binders hold, entrap, or otherwise coalesce the cluster components into the discrete particle. Notably, however, in some embodiments, an organic binder may not act strictly or entirely as a binder in the clusters (i.e., when an inorganic binder or other organic binder provides some or all of the mechanical coalescing necessary to form a cluster, some of an organic binder may not act to coalesce cluster components and may instead be coalesced by other binder material).

In some embodiments, the clusters contain an organic binder that is a latex material. Exemplary organic binders that may be used in the present disclosure include, but are not limited to, polyvinyl acetates, vinyl acrylics, styrene butadiene, styrenes, styrene acrylics, ethylene vinyl acrylics. Other exemplary binders are solvent-borne binders and water reducible binders.

In some approaches in which the organic binder is or contains a polymeric latex binder, the organic binder material or polymeric latex binder of the cluster may have a relatively low glass transition temperature (Tg) and in some embodiments the Tg of the organic binder material is from about 0° C. to about 60° C. In other embodiments, the Tg of the organic binder material is from about 5° C. to about 60° C., and in yet other embodiments, the Tg of the organic binder material is from about 15° C. to about 50° C.

As discussed above, the photoactive clusters may also comprise a binder void or space 28 which is an empty space or other pocket which forms within the photoactive cluster 20 during formation of the cluster—for example, during spray drying.

Another possible component of the cluster is so-called opaque polymer particles. These opaque polymer particles may include polymer that encloses or substantially encloses an opaque polymer void volume (such as voids 27 schematically illustrated in FIGS. 1 and 2). The opaque polymer may be or include discrete polymeric particles each defining a closed void volume therein. In some embodiments, the polymer of the opaque polymer is polystyrene. Suitable opaque polymers may be available from commercial vendors such as Ropaque Ultra EF or Ropaque OP-96 EF (both available from the Dow Chemical Company, Midland, Mich.). In some embodiments the opaque polymer void volume has a diameter or size from about 0.3 microns to about 0.8 microns. In other embodiments the opaque polymer void volume has a diameter or size from about 0.4 microns to about 0.7 microns. In other embodiments still, the opaque polymer void volume has a diameter or size from about 0.5 microns to about 0.6 microns. In some embodiments the opaque polymer may also have a polymer wall thickness from about 0.075 microns to about 0.150 microns. In other embodiments the opaque polymer has a polymer wall thickness from about 0.100 microns to about 0.120 microns.

The opaque polymer (or the polymer of the discrete polymeric particles each defining a closed void volume therein) may have a relatively high glass transition temperature (Tg) and in some embodiments the Tg of the opaque polymer is from about 100° C. to about 120° C. In other embodiments, the Tg of the opaque polymer is from about 100° C. to about 110° C. Thus, the glass transition temperature of the opaque polymer is generally higher than the glass transition temperature of any polymeric latex cluster binder used to coalesce cluster components. For instance and in some embodiments, a difference in Tg of any organic, polymeric latex cluster binder to the Tg opaque polymer is greater than about 80° C., in other embodiments, the difference in Tg of any polymeric latex cluster binder to the Tg opaque polymer is greater than about 40° C., and in yet other embodiments, the difference in Tg of any polymeric latex cluster binder to the Tg opaque polymer is greater than about 10° C.

The cluster particle may also include non-photoactive inorganic pigment particles having suitable surface treatments or other coatings to limit, hinder, or prevent photoactivity. Suitable non-photoactive pigment particles or inorganic particles useful in the cluster particles of the present disclosure may be surface-treated titanium dioxide (TiO2), zinc oxide (ZnO2), calcium carbonate (CaCO3), talc, clay materials, aluminum oxide, silicon dioxide, magnesium oxide, zinc sulfate, sodium oxide, potassium oxide, combinations thereof or other known pigment or inorganic particles suitable for paints and other coatings that have been treated to limit or hinder photoactivity. In some approaches, the non-photoactive pigment or inorganic particle is a non-photoactive titanium dioxide, which may comprise non-photoactive anatase titanium dioxide or non-photoactive rutile titanium dioxide, or a mixture of the two. In other approaches, the pigment or inorganic particle comprises non-photoactive rutile titanium dioxide to the exclusion of non-photoactive anatase titanium dioxide. In some approaches, the non-photoactive titanium dioxide is surface treated, coated, or encapsulated with an inorganic oxide, such as silica (SiO2), alumina oxide (Al2O3), and the like to limit and hinder photoactivity. Generally, titanium dioxide has a particle size of from about 0.2 to about 1.0 microns in diameter (in other approaches, about 0.2 to about 0.3 microns in diameter) and is provided in powder form, or in an aqueous slurry. An example of non-photoactive titanium dioxide that is suitable for use in the cluster together with the photoactive pigment may be Ti-Pure® R-706, which is commercially available from E.I. du Pont de Nemours and Company. Ti-Pure® R-706 titanium dioxide is a rutile titanium dioxide that is surface treated with silica. If added to a cluster, about 0.1% to about 89% percent by volume would be included.

Yet another possible cluster component is a so-called small sized extender particle. In an embodiment, the small-size extender of the present disclosure could be CaCO₃. Other non-limiting examples of materials which may be used as small-size extenders are clay, certain silicas (both ground and precipitated) when not acting as a binder, a fine talc or any other small extender that may be used in the art, and combinations thereof. In some embodiments, the small-size extenders are typically particles of less than 1 micron in size. In other embodiments, small size extenders are from about 0.1 microns to about 1.0 microns in size. In other embodiments, the small size extenders are from about 0.3 microns to about 0.8 microns. In other embodiments, the small size extenders are from about 0.5 microns to about 0.7 microns. Small-size extenders, as described herein, may overlap in scope with the set of silicon-containing particles described as a class of inorganic binders. A person having ordinary skill in the art will recognize that these materials are not, however, co-extensive, and that “silicon-containing particles,” as used herein are intended to refer to materials that will operate as binder in the clusters, while “small-size extenders” as used herein refers in particular to materials that may be added to the clusters or paint formulation as a filler-type material.

The above described components are coalesced by the cluster binder into a discrete photoactive cluster particle. It is believed the photoactive clusters are formed through mechanical interactions or coalescence of the binder and the various cluster constituents. In some approaches, there is no covalent or chemical bonding within the clusters. In some approaches, the cluster is formed by first making a slurry including the desired components and then forming the photoactive clusters via temperature elevation and clustering, such as by spray drying. Without wishing to be limited by theory, it is believed that due to at least the composition of the cluster and the spray drying forming process, the photoactive clusters herein also include unique porosity or interstitial networks including void volumes from pores, binder voids, channels, and/or opaque polymer void volumes due to water being driven out of the binder in the photoactive clusters during spray drying. In certain non-limiting embodiments, the void volume of a photoactive cluster may be about 1% to about 35% by total volume of the photoactive cluster. In other non-limiting embodiments, the void volume is from about 15% to about 30% by total volume of the photoactive cluster. In other non-limiting embodiments still, the void volume is from about 25% to about 30% by volume of the photoactive cluster.

In some exemplary embodiments, the volume percentage of solids of binder in a photoactive cluster is from about 1% to about 30%. In another exemplary embodiment, the volume percentage of solids of binder in a photoactive cluster is from about 5% to about 30%.

Some embodiments of the present photoactive cluster may have a volume percentage of solids of opaque polymer of from about 0% to about 80%. In other embodiments, the volume percentage of solids of opaque polymer in a photoactive cluster may be from about 10% to about 70%. In other embodiments still, the volume percentage of solids of opaque polymer in a photoactive cluster is from about 30% to about 50%.

In some exemplary embodiments, the volume percentage of solids of small-size extender included in each cluster is from about 0% to about 90%. In many embodiments, the volume percentage of solids of small size extender comprises the balance of the photoactive cluster.

In some approaches, the cluster may include a volume percentage of the silicon-containing particles from about 2 to about 30, in other approaches 4 to 20.

In other approaches, the cluster may include a volume percentage of pigment (both photoactive and non-photoactive) from about 1% to about 90%. The cluster may include about 1 to about 90 volume percent of photoactive pigment and about 0 to about 89 volume percent of non-photoactive pigment. In other approaches, the cluster may include about 1 to about 90 volume percent of anatase titanium dioxide in a photoactive form and about 0 to about 89 volume percent of non-photoactive titanium dioxide (either anatase or rutile).

In some exemplary approaches, the photoactive clusters may exhibit a density of about 7 to about 20 pounds/gallon. In other approaches, the photoactive clusters may exhibit a density of about 7 to about 15 pounds/gallon, and in yet other approaches, about 10 to about 12 pounds per gallon. It will be appreciated, that such exemplary densities apply to all the various approaches of photoactive clusters provided herein.

In some aspects, the photoactive clusters herein are structured or nano-engineered composite particles (meaning the cluster particles include nano-sized components) including the various particle constituents or components described throughout this disclosure. In some approaches, the constituents or particle components are generally uniformly or homogeneously dispersed or spread consistently throughout the composite particle. In some approaches, the cluster particles are spray dried particles. In other words, and in some approaches, the composite particles of this disclosure are not a core/shell-type structure and are free-of or devoid of any coatings or surface layers thereof prior to being combined in a latex paint composition. In yet other approaches, the photoactive clusters may be surface treated as needed to change surface characteristics thereof. In one approach, the outer surface of a photoactive cluster particle may be surface treated with one of a silane compound, a siloxane compound, a fluorine compound, an organic compound, or combinations thereof.

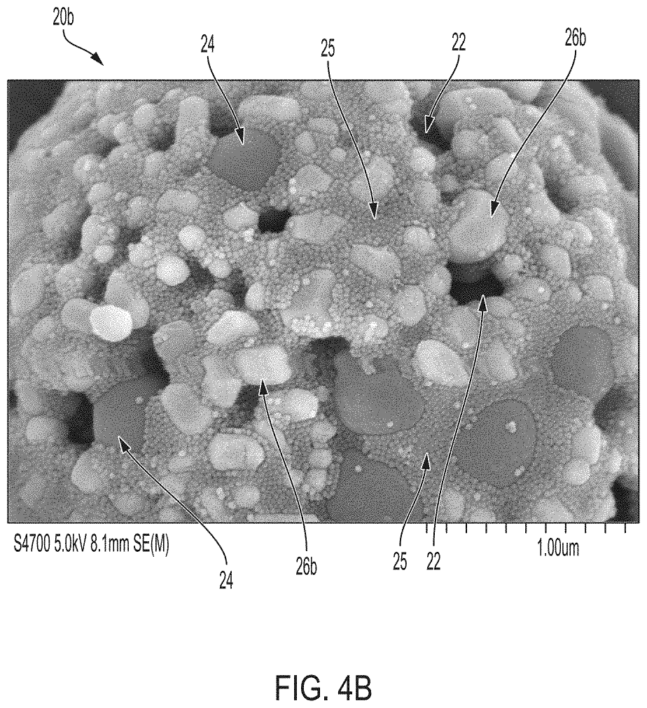

FIG. 4A shows a scanning electron microscopic image of an exemplary photoactive cluster formed according to the inventive methods described herein. The pictured, photoactive cluster 20 includes a volume of binder material that is, in this embodiment, entirely made up of silicon-containing particles 25, wherein an outer surface of the cluster 20 further includes a plurality of pores 22 extending on, in, or throughout the cluster particle. The plurality of pores 22 may collectively establish or form part of the interstitial network and/or porosity of the photoactive cluster 20. In the approach shown, the cluster components that the silicon-containing particles 25, acting as the binder, coalesce into a discrete particle include opaque polymer particles 24 (or discrete polymeric particles each defining a closed void volume therein), and photoactive pigment particles 26a (anatase titanium dioxide without surface treatment).

FIG. 4B shows a scanning electron microscopic image of a non-photoactive cluster formed according to the methods described herein but with no photoactive component. The pictured, non-photoactive cluster 20b includes a volume of binder material that is, in this instance, entirely made up of silicon-containing particles 25, wherein an outer surface of the cluster 20b further includes a plurality of pores 22 extending on, in, or throughout the cluster particle. The plurality of pores 22 may collectively establish or form part of the interstitial network and/or porosity of the non-photoactive cluster 20b. In the approach shown, the cluster components that the silicon-containing particles 25 coalesce into a discrete particle include opaque polymer particles 24 (or discrete polymeric particles each defining a closed void volume therein), and non-photoactive pigment particles 26b (rutile titanium dioxide with surface treatment).

Manufacture of Photoactive Clusters

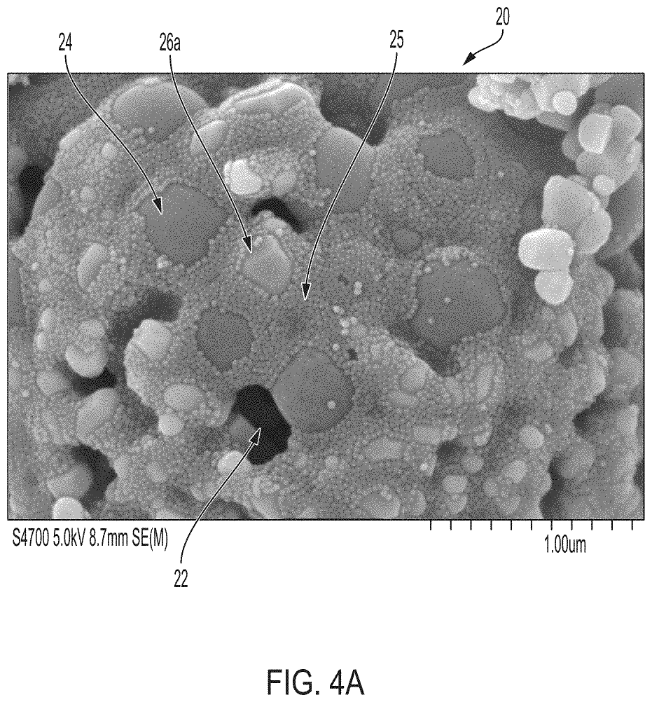

FIG. 3 provides an exemplary spray dryer 30 that may be used to manufacture the photoactive clusters of the present disclosure. According to the embodiment illustrated in FIG. 3, the spray dryer 30 includes an air supply blower 31 that feeds inlet air into a chamber 36 for atomizing a slurry comprising components to be included in the photoactive clusters, such as inorganic binder, pigment (photoactive and non-photoactive, opaque polymer, latex, and other conventional coatings additives (water, preservatives, defoamers, surfactants, pH modifiers, etc.), for example. Such conventional coatings additives are added as needed to provide a stable or semi-stable, adequately preserved slurry of the other components to be fed the spray dryer. Such additives may or may not end up in the spray dried cluster composition, depending on their chemical and physical nature. The air supply blower 31 can be a rotary, positive displacement fan, turbine, or any other suitable airflow device that can supply the volumetric flow rates into the chamber 36 to achieve the atomization described herein. An electric air heater 34 such as a radiant element, steam conduit, or other suitable heat source in thermal communication with the air supplied by the air supply blower 31 is operable to establish the desired temperature of the inlet air being introduced to the chamber 36 via a nozzle 38. The atomized slurry is drawn from the chamber 36 into a cyclone dryer by a negative pressure established by an exhaust blower 32 which, like the air supply blower 31, can be a rotary, positive displacement fan, turbine, or any other suitable airflow device that can establish the exhaust volumetric flow rates described herein. Once through the chamber 36, the entrained photoactive clusters in the form of a dry powder are removed from the airflow by a filter 33. The filter 33 can be any suitable separation device that can remove a substantial portion of the entrained powder from the airflow such as a cyclone separator, for example, that uses centrifugal force to expel the entrained powder radially outward, toward a perforated peripheral wall provided with a filter material, for example. The airflow can be occasionally interrupted to allow the particulate photoactive clusters to be deposited into a collection container 37, which can be isolated from the system with a large ball valve 40 or other suitable flow control device.

A controller 39 is provided to control operation of the various components of the spray dryer 30 in accordance with the methods of manufacturing the photoactive clusters described herein. An embodiment of the controller 39 generally includes a non-transitory, computer-readable medium 41 storing computer-executable instructions that, when executed by a computer processor 42, cause the controller 39 to communicate with the various operational components of the spray dryer 30 to manufacture the photoactive clusters 20 under the conditions described herein.

In use, the inlet air supply blower 31 and the exhaust blower 32 are started by the controller 39 to introduce a suitable amount of nozzle air to assist in atomization of the photoactive cluster slurry. Filters 33 on the spray dryer 30 are equipped with an air pulse mechanism 44 to occasionally release powder from filters 33. The electric air heater 34 is then set to deliver the desired temperature at the inlet 35.

When the temperature of the outlet of the chamber 36 reaches a certain point, such as about 85° C., then water is pumped to the atomizer at a rate to maintain a constant outlet temperature. Once the spray dryer 30 has reached steady state with the desired outlet temperature (selected to change drying profiles and/or avoid degradation of the desired cluster components) with only water and atomization air, the water feed is switched to the slurry including the components to be included in the photoactive clusters. Once through the chamber 36, the resultant dry powder is separated in a cyclone and collected in a container 37 using the ball valve 40 or any other valve that may be well-suited for such an application.

Size Distribution of Photoactive Clusters

In one embodiment, the photoactive clusters have an average particle size of from about 1 micron to about 44 microns. In another embodiment, the photoactive clusters have an average particle size of from about 5 microns to about 30 microns. In another embodiment still, the photoactive clusters have an average particle size of from about 7 microns to about 18 microns. In yet another embodiment, the photoactive clusters have an average particle size of from about 7 microns to about 12 microns.

Coating Composition

The photoactive clusters of this disclosure are suited for use in coating compositions, such as latex coating compositions useful as exterior architectural paints. When added to a paint composition as a photoactive element, they may replace at least a portion, which can optionally be less than all, or optionally all of the large size extenders or the non-photoactive pigments that would ordinarily be in a conventional paint composition. Alternatively, the photoactive clusters herein may be an additional component added to a conventional paint formulation to provide photoactive functionality. Thus, the photoactive clusters of the present disclosure may provide surface active properties, improved optical properties, or both as compared to a control paint composition without the photoactive clusters herein.

An exemplary volume percentage relative to total paint solids of photoactive clusters included in an illustrative embodiment of a paint composition is from about 5% to about 40%. In certain embodiments, the volume percentage of photoactive clusters in a paint composition is less than or equal to CPVC.

An exemplary embodiment of a paint according to the present disclosure is a paint product comprising at least one solvent, at least one paint formulation binder or latex, at least one non-photoactive pigment, at least photoactive clusters, and a PVC of the photoactive clusters and non-photoactive pigment with respect to the paint wherein the PVC is below the CPVC. In certain embodiments, the paint formulation binder is a polymeric binder that is different from the organic binder used in the photoactive clusters (if any organic binder is used). In certain embodiments, the paint formulation binder is the same material as an organic binder included in the photoactive clusters.

Coatings containing the photoactive clusters of this invention exhibit improved photoactive cleaning over equivalent coatings that do not contain the inventive photoactive clusters, and improved durability over coatings that contain photoactive materials that are free in a bulk coating phase (i.e., not contained by the photoactive clusters). Without being limited to theory, it is believed that photoactive clusters containing photoactive materials (like photoactive anatase titanium dioxide), when contained in a coating, segregate in distinct domains photoactive components separate from and/or spaced from the conventional coating componentry in a paint composition. Thus, the photoactive clusters are believed to minimize and/or control the degradation of the organic coating components due to the photoactive components. The photoactive cluster particles tend to include an interstitial void network within the clusters including voids, channels, or other network spaces of a size such that paint formulation binders and other organic coating componentry of a coating or paint that the clusters are blended in do not enter the voids or pores of the cluster particles. It is believed that dirt and grime may enter the voids or pores of the cluster particles and may thus be broken down.

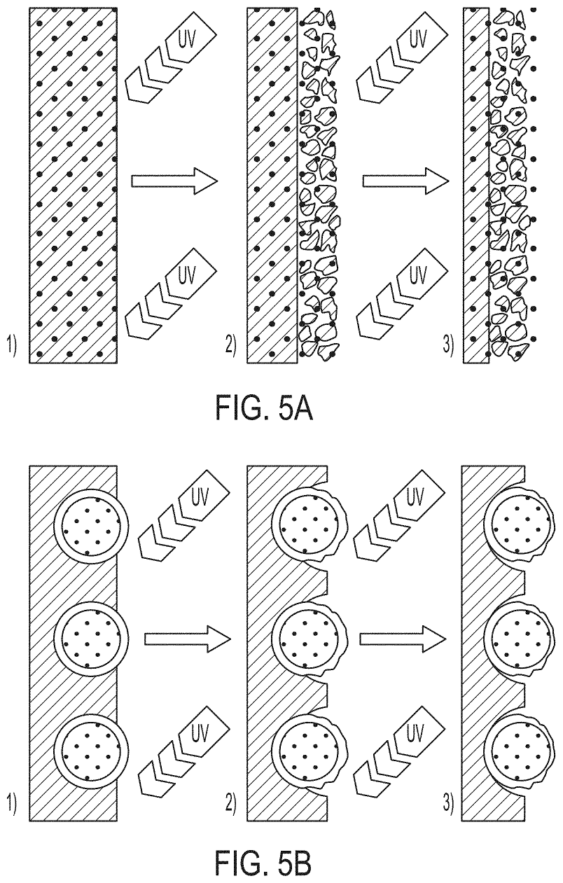

FIGS. 5A and 5B schematically illustrate the breakdown of organic components in a comparative, conventional coating and a coating containing exemplary photoactive clusters. FIG. 5A shows the comparative coating, which includes conventional organic coating components and photoactive components free in the bulk phase of the coating over time and with ultraviolet radiation exposure. FIG. 5B shows the coating containing exemplary photoactive clusters over time and with ultraviolet radiation exposure. The progression from steps 1) to 2) to 3) shows a theorized breakdown of the two coatings. The comparative, conventional coating in FIG. 5A steadily breaks down or chalks to much greater extent, because the organic, bulk phase of the comparative paint has consistent exposure to both the photoactive component and UV radiation across the entirety of an exposed surface of the coating. The exemplary coating (containing the exemplary photoactive clusters) shows some, but much less chalking in FIG. 5B. The photoactive materials in the exemplary coating are concentrated in the photoactive clusters and thus the amount of bulk, organic coating componentry that interfaces with the photoactive component and is exposed to UV radiation is limited to inside the clusters or at their interface with the bulk coating phase, if the photoactive component is at the outer surface of the photoactive clusters.

The photoactive cluster particles herein are suited for coatings, such as latex paints and provide a durable and active coating system. When the photoactive cluster particles are blended into a coating or other paint composition, the organic components of the coating or paint formulation generally do not enter or flow into the void space or network of the cluster particles. The photoactive cluster particles, thus, tend to remain a discrete or separate domain within the coating, which tends to aid in minimizing contact between the photoactive components and organic components of the coating bulk.

Coatings containing the photoactive clusters of this invention may further contain, in certain embodiments, conventional coatings additives, for example, biocides, preservatives, defoamers, surfactants, pH modifiers, and other additives as will be recognized by one having skill in the art. Such additives may be used and selected by a person having ordinary skill in the art to provide a stable or semi-stable, adequately preserved slurry of cluster components that can by spray dried to form photoactive clusters.

### EXAMPLES

The practice and advantages of the photoactive clusters and latex paint compositions including such clusters may be demonstrated by the following examples, which are presented for purposes of illustration and not limitation. Unless otherwise indicated, all amounts, percentages, and ratios of the Examples and elsewhere in this disclosure are by volume. Measurements of volume with respect to cluster composition refer to dry component volume as a percentage of the solid, dry cluster volume (not including any void volume).

Preparation of Clusters

Exemplary, inventive, photoactive clusters and comparative, non-photoactive clusters were prepared in accordance with the present specification by spray drying as described herein. Composition of the formed clusters is determined by the material content of the feed streams into the spray-drying process. The slurries that were spray dried to subsequently form example compositions in Cluster Examples 1-6 further contain conventional paint additives (preservatives, defoamers, surfactants, pH modifiers) as needed to form stable or semi-stable, preserved slurries that could be fed to the spray drying process. These conventional paint additives, when formulated to this purpose, are believed not to have any additional material effect on or function in the finished clusters. Further, the additional components are highly likely to “flash off” in the relatively high temperature, spray drying process.

Particle sizes of the example clusters described below were measured as follows: A Mastersizer 3000 (Malvern Instruments, Malvern, UK) was used to measure median particle size using an average of at least four measurements each of two samples of each lot. Samples were prepared by dispersing approximately 0.05 g of cluster powder in 10 ml of Type II Water. The samples were agitated for 10 seconds using a Vortex Mixer and then placed in an ultrasonic bath for 5 minutes to disperse the material. The measurements were performed in Type II Water using Refractive Index 2.680 (red source), Refractive Index 2.888 (blue source), Absorption Index 0.01 for both sources, and a general-purpose analysis model for irregular particles.

### Cluster Example 1—Comparative, Non-photoactive

A non-photoactive cluster was prepared by spray drying a 45.61% solids slurry (by volume of total slurry) of Ludox® AS-40 Colloidal Silica, Ropaque® OP-96 EF, and Kronos® R706 rutile titanium dioxide. On a volume percentage of solids basis, the finished cluster comprised 10% silica, 46% OP-96 EF, and 44% rutile titanium dioxide. The median particle size of the resulting clusters, as measured using a Malvern Mastersizer, was 13.8 microns. A scanning electron microscopy image of a cluster prepared according to Cluster Example 1 is shown in FIG. 4B.

### Cluster Example 2

An exemplary photoactive cluster was prepared by spray drying a 45.62% solids slurry (by volume of total slurry) of Ludox AS-40 Colloidal Silica, Kronos® 1000 anatase titanium dioxide, Kronos® R706 rutile titanium dioxide, and Minex® 10 (nepheline syenite). On a volume percentage of solids basis, the finished cluster comprised 20% silica, 26% anatase titanium dioxide, 28% rutile titanium dioxide, and 26% Minex® 10. The average particle size of the resulting clusters, as measured using a Malvern Mastersizer, was 11.2 microns.

### Cluster Example 3

Another exemplary photoactive cluster was prepared by spray drying a 45.61% solids slurry (by volume of total slurry) of Ludox® AS-40 Colloidal Silica, Kronos® 1000 anatase titanium dioxide, Minex® 10 (nepheline syenite), and Ropaque® OP-96 EF. On a volume percentage of solids basis, the finished cluster comprised 20% silica, 3% anatase titanium dioxide, 71% Minex® 10, and 6% OP-96 EF. The average particle size of the resulting clusters, as measured using a Malvern Mastersizer, was 11.8 microns.

### Cluster Example 4

Another exemplary photoactive cluster was prepared by spray drying a 45.60% solids slurry (by volume of total slurry) of Ludox® AS-40 Colloidal Silica, a proprietary, acrylic latex (“Latex A”), Kronos® 1000 anatase titanium dioxide, and Kronos® R706 rutile titanium dioxide. On a volume percentage of solids basis, the finished cluster comprised 11% silica, 9% Latex A, 7% anatase titanium dioxide, and 73% rutile titanium dioxide. The average particle size of the resulting clusters, as measured using a Malvern Mastersizer, was 15.6 microns.

### Cluster Example 5

An exemplary photoactive cluster was prepared by spray drying a 45.61% solids slurry (by volume of total slurry) of Ludox AS-40 Colloidal Silica, Kronos® 1000 anatase titanium dioxide, and Ropaque® OP-96 EF. On a volume percentage of solids basis, the finished cluster comprised 10% silica, 44% anatase titanium dioxide, and 46% Ropaque® OP-96 EF. The average particle size of the resulting clusters, as measured using a Malvern Mastersizer, was 9.93 microns. A scanning electron microscopy image of a cluster prepared according to Cluster Example 5 is shown in FIG. 4A.

### Cluster Example 6—Comparative, Non-photoactive

A non-photoactive cluster was prepared by spray drying a 45.59% solids slurry (by volume of total slurry) of Ludox® AS-40 Colloidal Silica, Minex® 10 (nepheline syenite), and Kronos® R706 rutile titanium dioxide. On a volume percentage of solids basis, the finished cluster comprised 40.7% silica, 56.6% Minex® 10, and 2.7% rutile titanium dioxide.

### Cluster Example 7

Another exemplary photoactive cluster was prepared by spray drying a 45.50% solids slurry (by volume of total slurry) of Ludox® AS-40 Colloidal Silica, Minex® 10 (nepheline syenite), and Kronos® 1000 anatase titanium dioxide. On a volume percentage of solids basis, the finished cluster comprised 40.7% silica, 56.6% Minex® 10, and 2.7% anatase titanium dioxide.

Preparation of Paints

Exemplary, inventive paint compositions incorporating said exemplary photoactive clusters and analogous, control paints, not containing photoactive clusters were also prepared, as described in Paint Compositions, below, each paint formulated to have a non-volatile volume of 40%.

### Control Paint Composition 1

A baseline, control paint containing no photo-active titanium dioxide either in free form or in cluster was prepared according to techniques that are standard to the art by running the grind in a high speed dispersion tank and completing the letdown/thin down of the materials described below in TABLE 1. Paint prepared according to Control Paint Composition 1 shall be referred to herein as “Control Paint 1.”

### Control Paint Composition 2—With Free, Photoactive, Anatase TiO2

A photoactive, non-inventive control paint containing free (in the bulk paint and not incorporated into a cluster), photoactive, anatase titanium dioxide (without surface treatment) was prepared according to techniques that are standard to the art by running the grind in a high speed dispersion tank and completing the letdown/thin down of the materials described below in TABLE 1. Paint prepared according to Control Paint Composition 2 shall be referred to herein as “Control Paint 2.”

### Control Paint Composition 3—With Non-photoactive Clusters

A third, control paint containing no photo-active titanium dioxide either in free form or in cluster, but including clusters with non-photoactive, rutile titanium dioxide, was prepared according to techniques that are standard to the art by running the grind in a high speed dispersion tank and completing the letdown/thin down of the materials described below in TABLE 1. Paint prepared according to Control Paint Composition 3 shall be referred to herein as “Control Paint 3.” Non-photoactive clusters of Cluster Example 6 were added with the letdown/thin down. The Example 6 clusters were added dry.

### Inventive Paint Composition 4

Paint prepared according to Inventive Paint Composition 4 shall be referred to herein as “Exemplary Paint 4.” Exemplary Paint 4 was prepared according to techniques that are standard to the art by running the grind in a high speed dispersion tank and completing the letdown/thin down of the materials described below in TABLE 1. Photoactive clusters of Example 7 were added with the letdown/thin down. The Example 7 clusters were added dry.

TABLE 1
Unless otherwise stated, all values in TABLE 1 are provided
in pounds per 100 gallons of fluid paint formulation.

| | | Control | Control | Exemplary |
|---|---|---|---|---|
| | | Paint 2- | Paint 3 | Paint 4 |
| | | Free | (with Non- | (with |
| | Control | Anatase | Photoactive | Photoactive |
| Component Description | Paint 1 | Added | Clusters) | Clusters) |
| WATER | 252.00 | 240.00 | 252.00 | 252.00 |
| Acronal Edge 4247-LATEX | 480.00 | 480.00 | 480.00 | 480.00 |
| CITROFLEX 4-COSOLVENT | 10.50 | 10.50 | 10.50 | 10.50 |
| KRONOS 1000-ANATASE | — | 2.85 | — | — |
| TIO2 (photoactive) | | | | |
| Ti-PURE R-706-RUTILE | 169.00 | 166.15 | 116.00 | 116.00 |
| TIO2 (non-photoactive) | | | | |
| MINEX 4-NEPHELINE | 52.44 | 52.44 | — | — |
| SYENITE-EXTENDER | | | | |
| WET GROUND 325 MESH | 13.00 | 13.00 | — | — |
| MICA-EXTENDER | | | | |
| EXAMPLE 6 CLUSTERS | — | — | 57.00 | — |
| EXAMPLE 7 CLUSTERS | — | — | — | 55.10 |
| TETRA POTASSIUM | 1.00 | 1.00 | 1.00 | 1.00 |
| PYROPHOSPHATE | | | | |
| AMMONIUM SALT | 5.00 | 5.00 | 5.00 | 5.00 |
| DISPERSANT | | | | |
| DYNOL 360-SURFACTANT | 2.00 | 2.00 | 2.00 | 2.00 |
| HINDERED AMINE LIGHT | 2.50 | 2.50 | 2.50 | 2.50 |
| STABILIZER | | | | |
| EUTECTIC PHOTOINIATOR | 1.25 | 1.25 | 1.25 | 1.25 |
| ZINC OXIDE-MILDEWSTAT | 50.00 | 50.00 | 50.00 | 50.00 |
| ZINC OMADINE EMULSION- | 0.20 | 0.20 | 0.20 | 0.20 |
| PRESERVATIVE | | | | |
| BIT PRESERVATIVE | 1.00 | 1.00 | 1.00 | 1.00 |
| FUNGICIDE | 5.00 | 5.00 | 5.00 | 5.00 |
| ATTAGEL CLAY 40- | 1.00 | 1.00 | 1.00 | 1.00 |
| ATTPULGITE | | | | |
| AQUAFLOW XLS-500- | 3.50 | 3.50 | 3.50 | 3.50 |
| RHEOLOGY MODIFIER | | | | |
| ACRYSOL RM-8W- | 5.40 | 5.40 | 5.40 | 5.40 |
| RHEOLOGY MODIFIER | | | | |
| ACRYSOL RM-2020 NPR- | 10.80 | 10.80 | 10.80 | 10.80 |
| RHEOLOGY MODIFIER | | | | |
| FOAMEX 810-DEFOAMER | 3.00 | 3.00 | 3.00 | 3.00 |
| BYK-022-DEFOAMER | 3.30 | 3.30 | 3.30 | 3.30 |
| AQUEOUS AMMONIA | 1.25 | 1.25 | 1.25 | 1.25 |

Each of the Paint Compositions 1-4 above were further characterized according to standard industry calculations or measurements as provided below in TABLE 2.

TABLE 2

| | | Control | Control | Exemplary |
|---|---|---|---|---|
| | | Paint 2- | Paint 3 | Paint 4 |
| | | Free | (with Non- | (with |
| | Control | Anatase | Photoactive | Photoactive |
| Measure | Paint 1 | Added | Clusters) | Clusters) |
| Density (pounds | 10.75 | 10.75 | 10.14 | 10.12 |
| per gallon) | | | | |
| Paint NVV (vol %) | 40 | 40 | 40 | 40 |
| 2.5 Mil Contrast ratio | 0.957 | 0.953 | 0.945 | 0.926 |
| Y-Reflectance value | 90.8 | 90.45 | 91.45 | 90.4 |
| 60° Gloss | 6.7 | 9.0 | 9.9 | 8.9 |
| 85° Sheen | 10.9 | 17.7 | 17.0 | 13.7 |

### Paint Test A: Dirt Resistance Testing

Each of the Paint Compositions 1-4 above were subjected to dirt resistance and accelerated weathering testing in an adaptation of ASTM D6540-17 (“Standard Test Method for Accelerated Soiling of Pile Yarn Floor Covering”) and ASTM D7897-18 (“Standard Practice for Laboratory Soiling and Weathering of Roofing Materials to Simulate Effects of Natural Exposure on Solar Reflectance and Thermal Emittance”) tests. Delta L (according to the FMC-II system, Friele, MacAdam, and Chickering) is measured in triplicate with respect to each Paint Composition after soiling as an indication of dirt resistance, likely resulting from photoactivity of paint components. For each of Paint Composition 1-4, three, 15-mil drawdowns of the coatings were done on aluminum Q-panels. Each panel was allowed to dry at ambient conditions overnight, then one hour at 120° F. A total of twelve trials were run (three panels for each of Paint Compositions 1-4).

First, the panels were placed in a QUV Weathering Tester (available from Q-LAB Corporation) for 4 hours UV exposure, cycle only. Each panel was then allowed to sit overnight at room temperature and humidity. An initial reading was taken for each panel on an X-Rite VS450 non-contact spectrophotometer and taken as “Standard A”—the spectrophotometer is set for D-65-10, FMC-II.

A soil sample is stirred for 1 minute with a spatula or tongue depressor (soil may be carpet synthetic soil used in ASTM D6540-17 or soils identified in ASTM D7897-18). A No. 30 standard mesh stainless sieve was placed directly onto each test panel. 1.0 g of soil was applied to each film through the sieve. With soil D6540, some larger components will remain on the sieve and may be disposed of.

Each panel was then inverted and held at the horizontal to remove loose soil, and then the backs of the panels were tapped gently to dislodge weakly bound soil. The soiled area of each panel was measured again with the spectrophotometer to provide an intermediate reading. Each panel was then held in a panel rack to be sprayed by a spraying apparatus. Each panel was sprayed with water for 10 minutes at 25-30 PSI using a QGA-SS5 nozzle (available from Spraying Systems Co., an IEEE GlobalSpec company), which simulates a heavy rain. The panels were removed from the chamber and gently tapped on the back to remove the excess water from the surface of the panels. The soiled surface is never touched. The panels were allowed to dry for 3 hours while lying flat on a horizontal surface.

The X-Rite VS450 non-contact spectrophotometer was then used to make a final reading of each of the dry panels. Five final readings were made for each panel. Delta L, FMC-II is reported as the average of the differences between each final reading and Standard A. The test method was run on three separate draw-downs for each Paint Composition and the average of those three delta L measurements is reported for each paint below in TABLE A.

TABLE A

| | | Control | Control | Exemplary |
|---|---|---|---|---|
| | | Paint 2- | Paint 3- | Paint 4- |
| | | Free | with Non- | with |
| | Control | Anatase | Photoactive | Photoactive |
| Description | Paint 1 | Added | Clusters | Clusters |
| Delta L (FMC-II) | −3.20 | −2.69 | −3.10 | −2.24 |

Exemplary Paint 4 shows delta L of lowest magnitude of the set. Control Paint 2 also shows moderately low magnitude delta L. This may be the result of the inclusion of photoactive anatase either in the inventive, photoactive clusters, or in free form in the bulk paint, respectively.

### Paint Test B: Change in Gloss after EMMAQUA Weathering and UV Exposure

Each of the Paint Compositions 1-4 were also tested for retention of gloss following exposure to UV radiation and enhanced weathering as a measure or indication of chalking under UV exposure. It is believed that a greater reduction in gloss is indicative of greater chalking potentially due to photoactivity of coating components. For each of Paint Composition 1-4, three panels were painted using a 6-mil bird drawdown bar over 3″×6″ aluminum Q-panels and allowed to dry for 7 days. Initial gloss and color readings were taken using a Byk-Gardner (Catalog #4601) Gloss-Haze Meter and a Gretag-MacBeth Coloreye 2145. Initial visible spectrophotometer measurements are stored as “Standard B”. Panels were sent for EMMAQUA (“Equatorial Mount with Mirrors for Acceleration with Water”) exposure for a total of 300 MegaJoules Solar irradiance. Panels were returned and all are remeasured using the same Gloss-Haze Meter and Coloreye. The values are compared to Standard B and the gloss loss reported as (Initial Gloss−Final Gloss)/(Initial Gloss)*100. Results for the four Paint Compositions (an average of three runs for each Paint Composition) are shown below in TABLE B.

TABLE B

| | | Control | Control | Exemplary |
|---|---|---|---|---|
| | | Paint 2- | Paint 3- | Paint 4- |
| | | Free | with Non- | with |
| | Control | Anatase | Photoactive | Photoactive |
| Description | Paint 1 | Added | Clusters | Clusters |
| % drop in 60 Deg | 12.27 | 41.28 | 22.17 | −3.99 |
| Gloss (after 300 | | | | |
| MJ EMMAQUA) | | | | |

Exemplary Paint 4 shows the least loss in percentage gloss. Control Paints 1 and 3 each show moderate loss in percentage gloss, and Control Paint 2 shows the greatest loss in percentage gloss.

In all examples and throughout this disclosure, unless otherwise specified, all measurements herein are made at about 23+/−1° C. and about 50% relative humidity. The dimensions and values disclosed herein are not to be understood as being strictly limited to the exact numerical values recited. Instead, unless otherwise specified, such as dimension is intended to mean both the recited value and a functionally equivalent range surrounding that value. For example, a dimension disclosed as “40 mm” is intended to mean “about 40 mm”.

It is also to be noted that the phrase “at least one of”, if used herein, followed by a plurality of members herein means one of the members, or a combination of more than one of the members. For example, the phrase “at least one of a first component and a second component” means in the present application: the first component, the second component, or the first component and the second component. Likewise, “at least one of a first component, a second component and a third component” means in the present application: the first component, the second component, the third component, the first component and the second component, the first component and the third component, the second component and the third component, or the first component and the second component and the third component and so forth.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A photoactive cluster particle for durable latex paint compositions, the photoactive cluster particle comprising:
a binder coalescing cluster components into a cluster particle;
the cluster components of the cluster particle including a photoactive component, one or more silicon-containing particles, optional discrete polymeric particles each defining a closed void volume therein, optional non-photocatalytic inorganic pigment particles, optional organic latex polymer, and optional extender pigment particles; and
an interstitial void network of the cluster particle forming a porosity thereof.

2. The photoactive cluster particle of claim 1, wherein the one or more silicon-containing particles include silicon dioxide particles that act as the binder or a portion of the binder.

3. The photoactive cluster particle of claim 2, wherein the silicon dioxide particles have a sub-micron average particle size.

4. The photoactive cluster particle of claim 1, wherein the photoactive component is titanium dioxide in a photocatalytic form having an average particle size of about 0.2 to about 1.0 microns.

5. The photoactive cluster particle of claim 1, further comprising non-photocatalytic titanium dioxide in a form selected from anatase, rutile, or combinations thereof

6. The photoactive cluster particle of claim 1, further comprising a surface treatment of an outer surface of the cluster particle with one of a silane compound, a siloxane compound, a fluorine compound, an organic compound, or combinations thereof.

7. The photoactive cluster particle of claim 1, wherein the binder includes the silicon-containing particles and the organic latex polymer, and wherein the silicon-containing particles include silicon dioxide.

8. The photoactive cluster particle of claim 1, further comprising the discrete polymeric particles each defining a closed void volume therein and wherein the cluster particle has a total void volume including a total closed void volume of all the discrete polymeric particle closed void volumes and the interstitial void network of the cluster particle.

9. The photoactive cluster particle of claim 8, wherein the total void volume is from about 1 percent to about 35 percent by volume of the cluster particle.

10. The photoactive cluster particle of claim 8, wherein a space forming the closed void volume of the discrete polymeric particle has a size from about 0.4 microns to about 0.7 microns.

11. The photoactive cluster particle of claim 1, wherein an average particle size of the cluster particle is about 1 to about 44 microns.

12. The photoactive cluster particle of claim 1, wherein the cluster particle has an outer surface defined at least by a portion of the photoactive component and wherein the outer surface has a surface porosity defined by a portion of the interstitial void network.

13. The photoactive cluster particle of claim 1, wherein the porosity is formed by one or more interstices each from about 0.050 μm to about 0.150 μm in cross-sectional size.

14. The photoactive cluster particle of claim 1, comprising:
about 1 percent to about 30 percent by volume of the dry cluster volume of the binder, wherein the binder comprises the one or more silicon-containing particles,
about 1 percent to about 90 percent by volume of the photoactive component wherein the photoactive component is titanium dioxide in a photocatalytic form,
about 0 to about 85 percent by volume of non-photocatalytic inorganic pigment particles,
about 0 to about 80 percent by volume of the discrete polymeric particles each defining a closed void volume therein, and
about 0 to about 90 percent by volume of the extender pigment particles.

15. A durable and photoactive latex paint composition, the latex paint composition comprising:
a solvent, a polymeric paint formulation binder, non-photocatalytic pigment particles, and photoactive cluster particles;
the photoactive cluster particles including a cluster binder comprising one or more silicon-containing particles and the same, different, or no latex polymer as the polymeric paint formulation binder, the cluster binder coalescing cluster components into a discrete cluster particle, wherein the cluster components of the discrete cluster particle include an inorganic photoactive pigment component, optional discrete polymeric particles each defining a closed void volume therein, optional non-photocatalytic inorganic pigment particles, and optional extender pigment particles, and wherein the discrete cluster particle has an interstitial void network forming a porosity thereof.

16. The durable and photoactive latex paint composition of claim 15, wherein the one or more silicon-containing particles of the discrete cluster particle includes silicon dioxide particles.

17. The durable and photoactive latex paint composition of claim 15, wherein the latex polymer binder of the discrete cluster particle includes an acrylate latex polymer binder.

18. The durable and photoactive latex paint composition of claim 15, wherein the silicon dioxide particles have a sub-micron average particle size.

19. The durable and photoactive latex paint composition of claim 15, wherein the inorganic photoactive pigment component is titanium dioxide in a photocatalytic form having an average particle size of about 0.2 to about 1.0 microns.

20. The durable and photoactive latex paint composition of claim 19, wherein the discrete cluster particle further includes the non-photocatalytic titanium dioxide in a form selected from anatase, rutile, or combinations thereof

21. The durable and photoactive latex paint composition of claim 15, wherein at least a portion of the outer surface of the discrete cluster particles includes a surface treatment with one of a silane compound, a siloxane compound, a fluorine compound, an organic compound, or combinations thereof.

22. The durable and photoactive latex paint composition of claim 15, wherein the discrete cluster particle further includes the discrete polymeric particles each defining a closed void volume therein and wherein the discrete cluster particle has a total void volume including a total closed void volume of all the discrete polymeric particle closed void volumes and the interstitial void network of the discrete cluster particle.

23. The durable and photoactive latex paint composition of claim 22, wherein the total void volume is from about 1 percent to about 35 percent by volume.

24. The durable and photoactive latex paint composition of claim 23, wherein a space forming the closed void volume of the discrete polymeric particle has a size from about 0.4 microns to about 0.7 microns.

25. The durable and photoactive latex paint composition of claim 15, wherein an average particle size of the discrete cluster particle is about 5 to about 44 microns.

26. The durable and photoactive latex paint composition of claim 15, wherein the discrete cluster particle has an outer surface defined at least by a portion of the inorganic, photoactive pigment component and wherein the outer surface has a surface porosity defined by a portion of the interstitial void network.

27. The durable and photoactive latex paint composition of claim 26, wherein the surface porosity is formed by one or more interstices each from about 0.050 um to about 0.150 um in cross-sectional size.

28. The durable and photoactive latex paint composition of claim 15, wherein the latex paint composition includes about 5 to about 40 percent of the photoactive cluster particles by volume of paint solids.
